(19) United States
(12) Patent Application Publication
(10) Pub. No.: US 2019/0228418 A1
(43) Pub. Date: Jul. 25, 2019

(54) ELECTRONIC EMPLOYMENT DOCUMENT CONTROL SYSTEM WITH MOBILE APPLICATION

(71) Applicant: Joey Sanchez, Ontario, CA (US)

(72) Inventor: Joey Sanchez, Ontario, CA (US)

(21) Appl. No.: 16/049,802

(22) Filed: Jul. 30, 2018

Related U.S. Application Data
(60) Provisional application No. 62/538,283, filed on Jul. 28, 2017.

(51) Int. Cl. G06Q 30/00

(52) U.S. Cl. CPC G06Q 30/018

(57) ABSTRACT

Methods, systems and computer readable media for electronic employment document control and employee communications system, including a mobile application, are described.

### RELATED APPLICATIONS

This application claims priority to U.S. Application No. 62/538,283, entitled “Electronic Employment Document Control System with Mobile Application,” filed on Jul. 28, 2018, which is incorporated herein by reference in its entirety.

### TECHNICAL FIELD

Embodiments relate generally to electronic employment document systems, and more particularly, to methods, systems and computer readable media for electronic employment document control and compliance systems and providing a mobile application for employment compliance and communications.

### BACKGROUND

Employers with 20 to 500 employees may often lack internal systems and resources to adequately control and maintain employment compliance records, documentation and communications between employer and its employees. This can be especially true when employees work off site or are contracted out at a third party location. Heightened government regulation and penalties for employers has increased employer exposure and risk for fines and lawsuits.

Some implementations were conceived in light of the above mentioned needs, problems and/or limitations, among other things.

### SUMMARY

In general, some implementations can include a cloud based software application that operates in conjunction with an associated smart phone (or mobile) application to provide a system for employers to provide employees with required employee disclosures (e.g., compliance media items such as documents, audio or video) and to document the process of employee review of the compliance items for proof of compliance. Some implementations can also permit two-way communication between employees and their employer to address their needs in an efficient, confidential and time sensitive manner, which can help to reduce an employer's exposure to risks that an employee's concerns, complaints, and/or injuries were not handled in a timely manner by a process that is documented.

Some implementations can include a method including receiving, at a processor, one or more compliance media items, and associating, with the processor, the one or more compliance media items with one or more employee accounts corresponding to one or more employees, wherein the associating indicates that review of the compliance media item is required of the one or more employees. The method can also include transmitting, with the processor, a notification to one or more mobile computing devices corresponding to the one or more employee accounts, wherein the notification includes an indication that the one or more compliance media items are awaiting review by the one or more employees. The method can further include receiving, at the processor, an indication that the one or more compliance media items have been reviewed by the one or more employees.

The method can also include storing, using the processor, the indication that the one or more compliance media items have been reviewed by the one or more employees to create a compliance audit trail for the one or more employees, and updating, using the processor, a management user interface to indicate that the one or more compliance media items have been reviewed by the one or more employees.

The one or more compliance media items can include one of a document, an audio file, or a video file. The indication that the one or more compliance media items have been reviewed by the one or more employees can include one or more of a date the one or more compliance media items have been reviewed by the one or more employees, a time the one or more compliance media items have been reviewed by the one or more employees, a device used to review the one or more compliance media items by the one or more employees, or a location the one or more compliance media items were reviewed at by the one or more employees.

The method can also include generating a report indicating which employees have reviewed or not reviewed the one or more compliance media items. The method can further include providing a communication interface between a management system and the one or more mobile computing devices corresponding to the one or more employee accounts, wherein the communications interface provides a private secure communications system for the one or more employees to communicate with one or more managers associated with the management system.

The communications interface can include capabilities to permit the one or more employees to communicate with one or more of a manager, a human resources representative, a safety/injury representative, or an executive. Communication messages with the one or more employees can be stored to create a documentation trail for the one or more employees and management.

Some implementations can include a system comprising a processor coupled to a nontransitory computer readable medium having stored thereon software instructions that, when executed by the processor, cause the processor to perform operations. The operations can include receiving, at the processor, one or more compliance media items, and associating, with the processor, the one or more compliance media items with one or more employee accounts corresponding to one or more employees, wherein the associating indicates that review of the compliance media item is required of the one or more employees. The operations can also include transmitting, with the processor, a notification to one or more mobile computing devices corresponding to the one or more employee accounts, wherein the notification includes an indication that the one or more compliance media items are awaiting review by the one or more employees.

The operations can further include receiving, at the processor, an indication that the one or more compliance media items have been reviewed by the one or more employees, and storing, using the processor, the indication that the one or more compliance media items have been reviewed by the one or more employees to create a compliance audit trail for the one or more employees. The operations can also include updating, using the processor, a management user interface to indicate that the one or more compliance media items have been reviewed by the one or more employees.

The one or more compliance media items can include one of a document, an audio file, or a video file. The indication that the one or more compliance media items have been reviewed by the one or more employees can include one or more of a date the one or more compliance media items have been reviewed by the one or more employees, a time the one or more compliance media items have been reviewed by the one or more employees, a device used to review the one or more compliance media items by the one or more employees, or a location the one or more compliance media items were reviewed at by the one or more employees.

The operations can also include comprise generating a report indicating which employees have reviewed or not reviewed the one or more compliance media items. The operations can further include providing a communication interface between a management system and the one or more mobile computing devices corresponding to the one or more employee accounts, wherein the communications interface provides a private secure communications system for the one or more employees to communicate with one or more managers associated with the management system.

The communications interface can include capabilities to permit the one or more employees to communicate with one or more of a manager, a human resources representative, a safety/injury representative, or an executive. Communication messages with the one or more employees can be stored to create a documentation trail for the one or more employees and management.

Some implementations can include a non-transitory computer readable medium having stored thereon software instructions that, when executed by a processor, cause the processor to perform operations. The operations can include receiving, at the processor, one or more compliance media items, and associating, with the processor, the one or more compliance media items with one or more employee accounts corresponding to one or more employees, wherein the associating indicates that review of the compliance media item is required of the one or more employees. The operations can also include transmitting, with the processor, a notification to one or more mobile computing devices corresponding to the one or more employee accounts, wherein the notification includes an indication that the one or more compliance media items are awaiting review by the one or more employees.

The operations can further include receiving, at the processor, an indication that the one or more compliance media items have been reviewed by the one or more employees, and storing, using the processor, the indication that the one or more compliance media items have been reviewed by the one or more employees to create a compliance audit trail for the one or more employees. The operations can also include updating, using the processor, a management user interface to indicate that the one or more compliance media items have been reviewed by the one or more employees.

The one or more compliance media items can include one of a document, an audio file, or a video file. The indication that the one or more compliance media items have been reviewed by the one or more employees can include one or more of a date the one or more compliance media items have been reviewed by the one or more employees, a time the one or more compliance media items have been reviewed by the one or more employees, a device used to review the one or more compliance media items by the one or more employees, or a location the one or more compliance media items were reviewed at by the one or more employees.

The operations can also include comprise generating a report indicating which employees have reviewed or not reviewed the one or more compliance media items. The operations can further include providing a communication interface between a management system and the one or more mobile computing devices corresponding to the one or more employee accounts, wherein the communications interface provides a private secure communications system for the one or more employees to communicate with one or more managers associated with the management system.

The communications interface can include capabilities to permit the one or more employees to communicate with one or more of a manager, a human resources representative, a safety/injury representative, or an executive. Communication messages with the one or more employees can be stored to create a documentation trail for the one or more employees and management.

### BRIEF DESCRIPTION OF THE DRAWINGS

FIG. 1 is a diagram of an example electronic employment document control system in accordance with some implementations.

FIG. 2 is an example user interface for an authentication for an electronic employment document control system in accordance with some implementations.

FIG. 3 is an example user interface showing a dashboard for an electronic employment document control system in accordance with some implementations.

FIG. 4 is an example user interface for client information entry and updating for an electronic employment document control system in accordance with some implementations.

FIG. 5 is an example user interface for adding employees to an electronic employment document control system in accordance with some implementations.

FIG. 6 is an example user interface for entering employee information in an electronic employment document control system in accordance with some implementations.

FIG. 7 is an example user interface for electronic employee compliance tracking in an electronic employment document control system in accordance with some implementations.

FIG. 8 is an example user interface for uploading an electronic compliance document to an electronic employment document control system in accordance with some implementations.

FIG. 9 is an example user interface for an electronic compliance log in an electronic employment document control system in accordance with some implementations.

FIG. 10 is an example user interface for composing a message in an electronic employment document control system in accordance with some implementations.

FIG. 11 shows example user interfaces for a mobile application associated with an electronic employment document control system in accordance with some implementations.

FIG. 12 shows example user interfaces for a mobile application associated with an electronic employment document control system in accordance with some implementations.

FIG. 13 shows example user interfaces for a mobile application associated with an electronic employment document control system in accordance with some implementations.

FIG. 14 is a diagram of an example computing device configured for electronic employment document control in accordance with at least one implementation.

### DETAILED DESCRIPTION

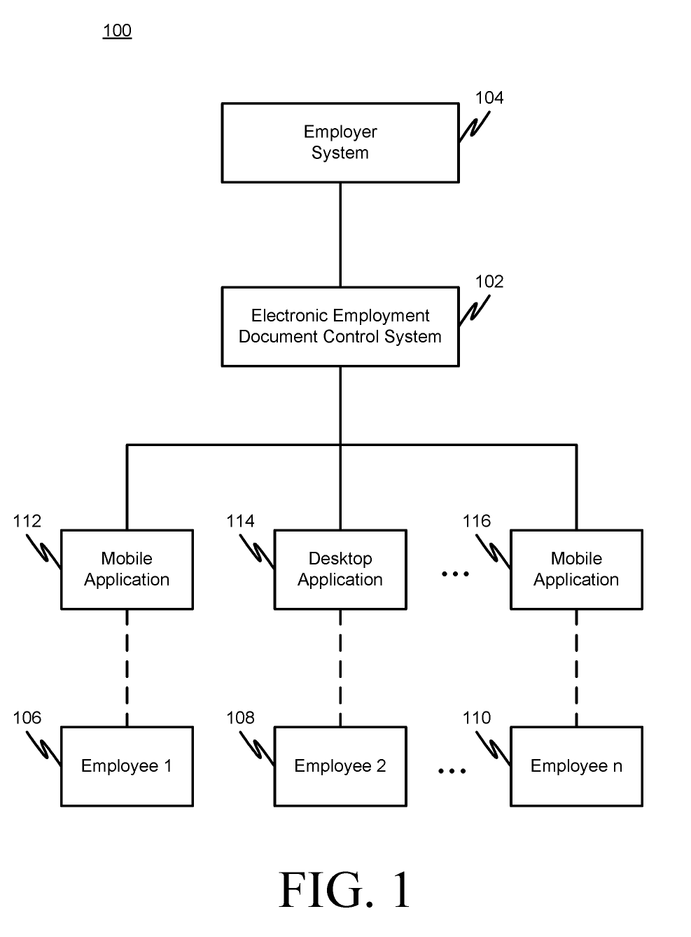

FIG. 1 is a diagram of an example operational environment 100 for an electronic employment document control system 102 in accordance with some implementations. The environment 100 includes the electronic employment document control system 102, one or more employer systems 104. One or more employees 106-110 can access the electronic employment document control system 102 via respective mobile or desktop applications 112-116. Administrators can also access the employer system 104 via a desktop application (e.g., 114) or a mobile application (e.g., 112, 116).

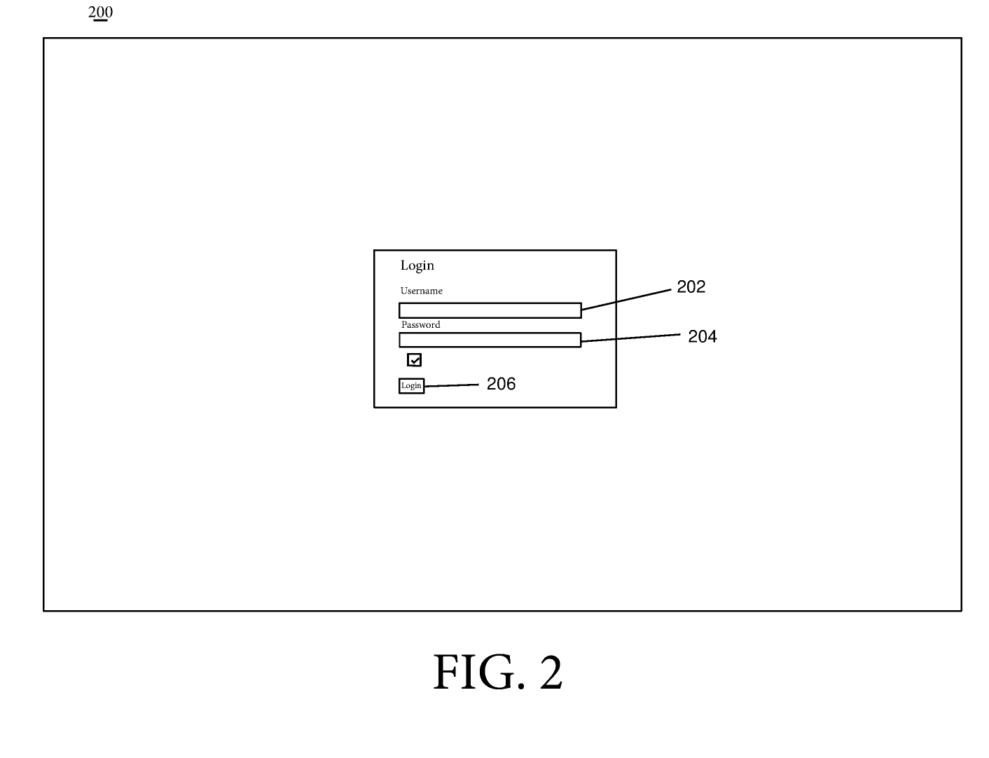

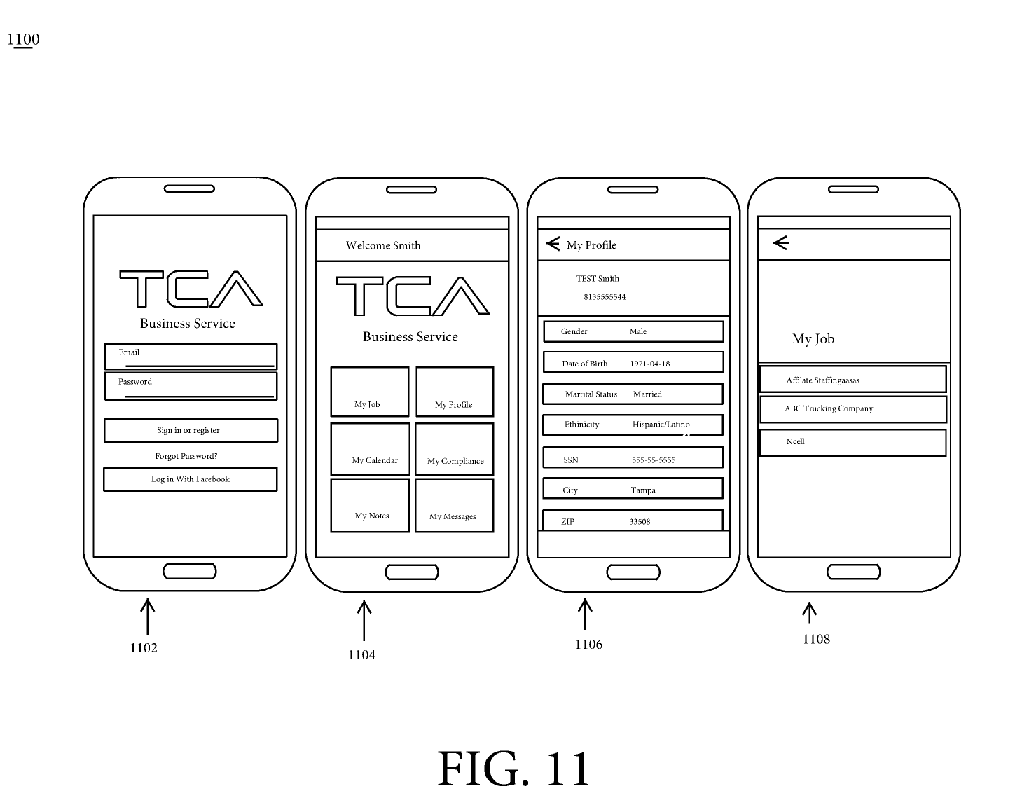

Example user interface screens for the administrator interface are shown in FIGS. 2-10. Example user interface screens for the mobile application are shown in FIGS. 11-13.

FIG. 2 is an example user interface 200 for an authentication for an electronic employment document control system 102 in accordance with some implementations. The interface 200 includes elements for a user to enter login or authentication credentials (e.g., username 202 and password 204). Once user name and password are entered, the user can select the login element 206 to cause the electronic employment document control system 102 to authenticate the user. The authentication can be performed for an administrator accessing the employer side of the system or for an employee accessing the electronic employment document control system 102 via a mobile application or desktop application.

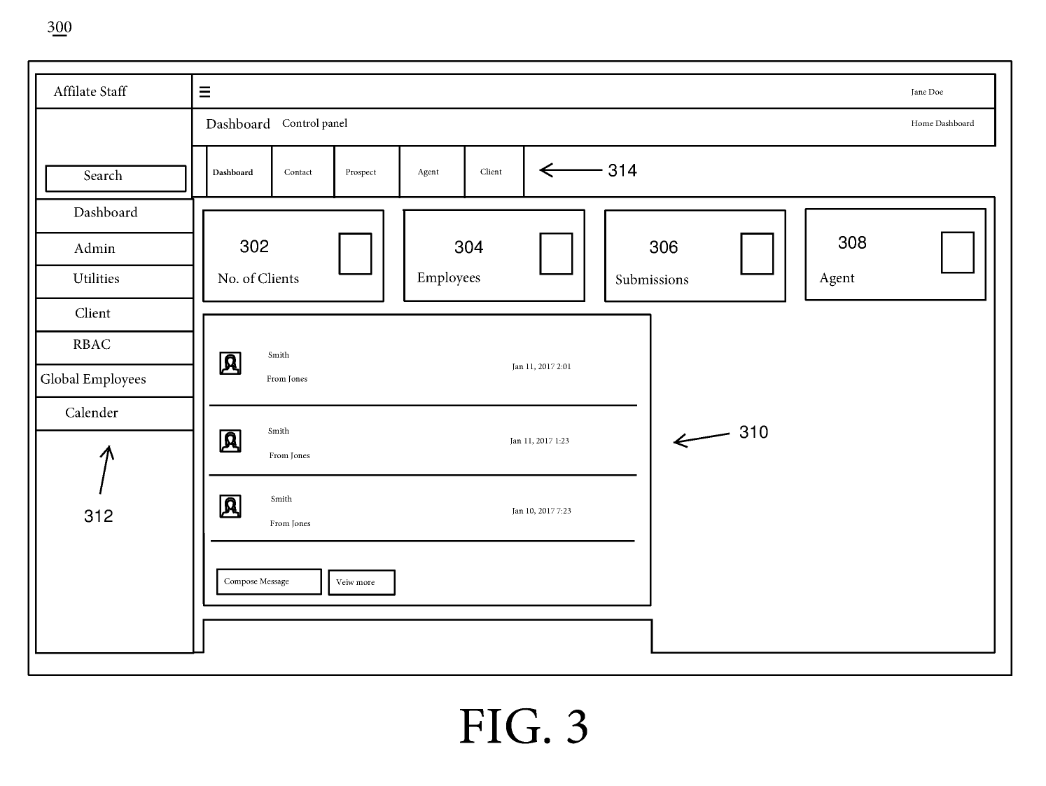

FIG. 3 is an example user interface showing a dashboard 300 for an electronic employment document control system in accordance with some implementations. The dashboard 300 includes elements showing number of clients (e.g., employers) 302, employees 304, submissions 306, and agents 308. Other metrics can be shown. The dashboard also includes a communication message section 310 showing recent messages and a “todo list” section for listing tasks to be completed. A navigation section 312 to the left hand side of the interface lists icons for navigating to the dashboard, an admin section, utilities, client information, RBAC, global employee listing and calendar. A top icon navigation system 314 includes icons corresponding to the dashboard, contact, prospect, agent, and client sections.

From the messaging section 310, a use is able to compose messages to client or employees within the system. These messages are exchanged via a private email system within the document control system.

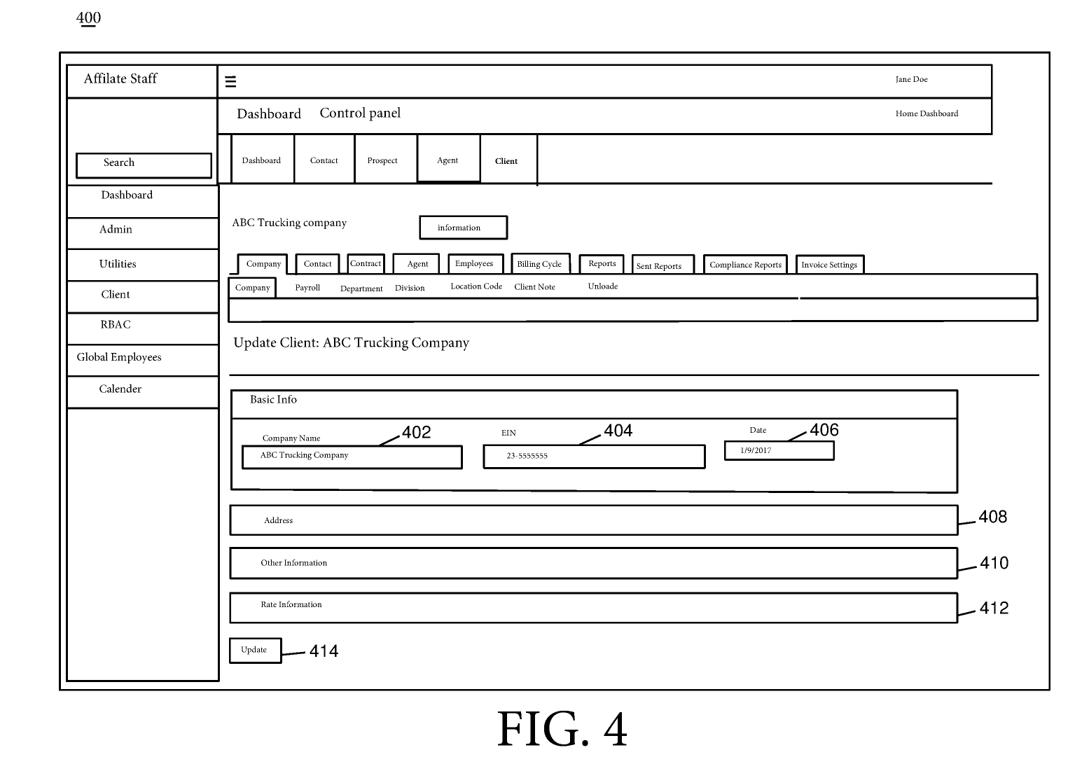

FIG. 4 is an example user interface 400 for client information entry and updating for an electronic employment document control system in accordance with some implementations. A client can include a company at which employees work. The employees may work for a third party (e.g., a staffing agency) that operates the electronic employment document control system. The client information user interface 400 can include a user interface element for client name 402, client identification number (e.g., EIN) 404, date 406, address 408, other information (e.g., notes, etc.) rate information, and an update element 414 that when selected updates the client record with information from the interface 400.

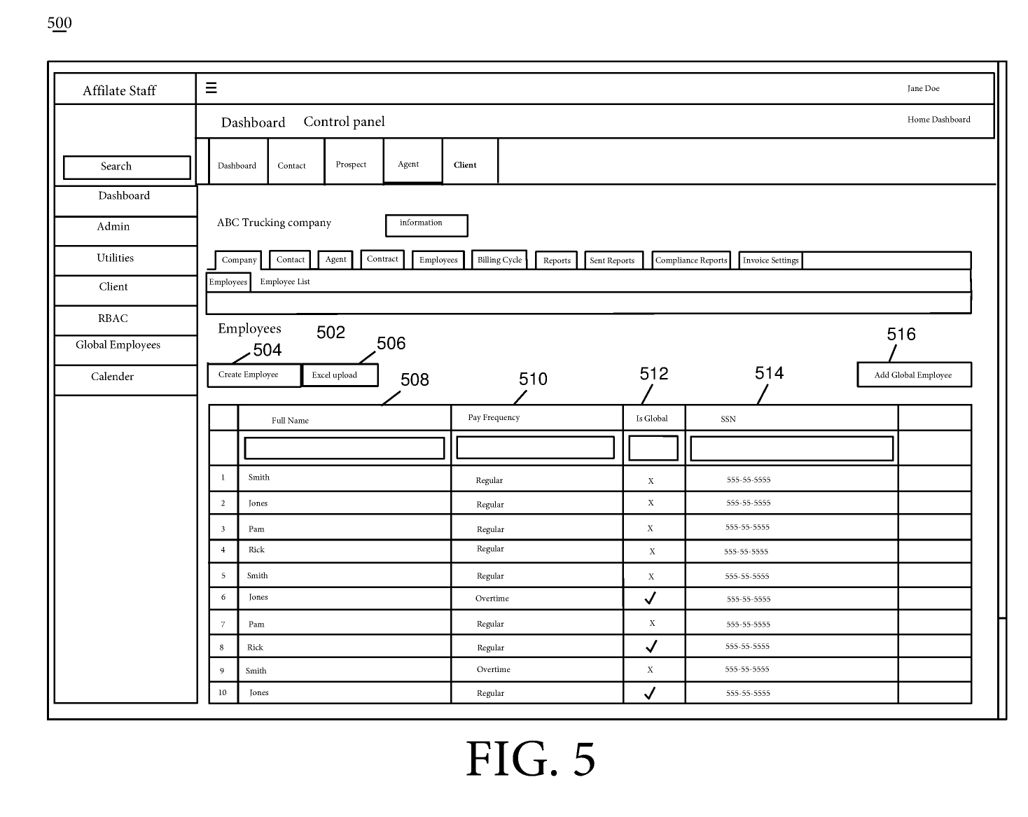

FIG. 5 is an example user interface 500 for adding employees to an electronic employment document control system in accordance with some implementations. Employees can be added individually (e.g., via selecting user interface element 504 within employee section 502) or via bulk (e.g., excel spreadsheet upload 506). Elements for displaying, adding, or editing employee information can include a name element 508, a pay frequency element 510, a global element 512, and an employee identifier (e.g., social security number) 514. The interface 500 also includes an element 516 for adding a global employee.

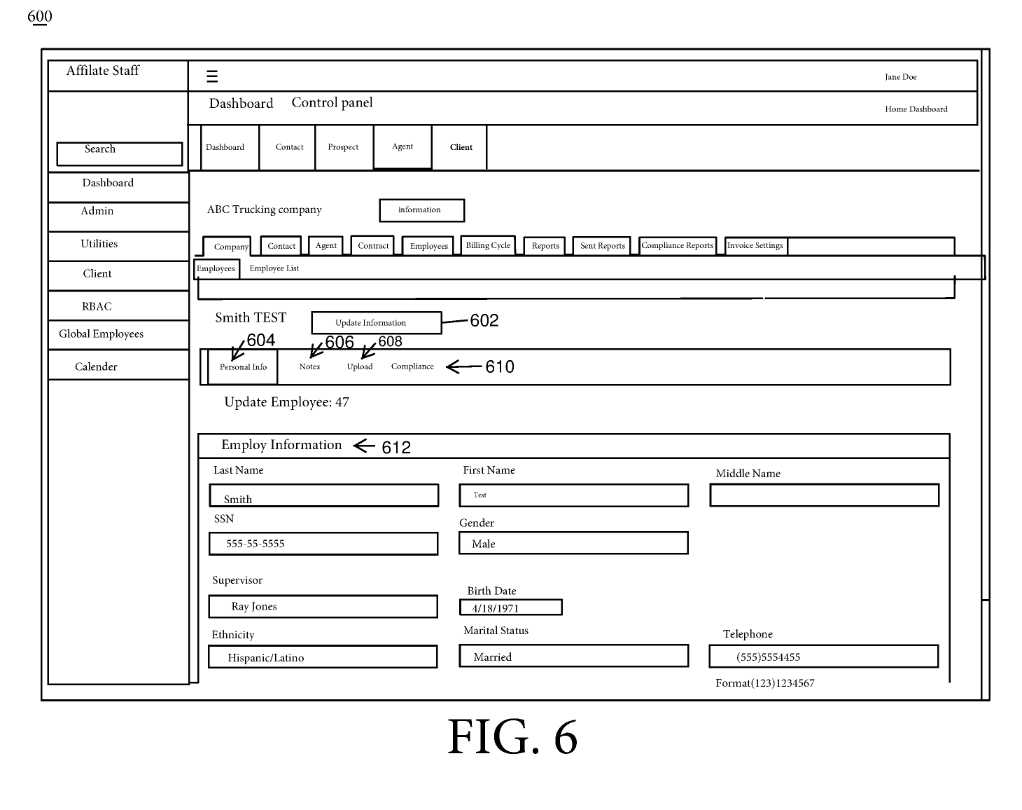

FIG. 6 is an example user interface 600 for entering and/or updating employee information in an electronic employment document control system in accordance with some implementations. An employer can access employee personal information via user interface element 604 that, when selected, displays employee information 612, which can include employee name, social security number, gender, supervisor, ethnicity, marital status, telephone number, or address, etc. The interface 612 can permit a user to add, delete or modify employee information. Once employee information has been added, deleted or modified, the employee information record can be updated by selecting the update information element 602.

The employee information interface 600 also includes elements for notes 606, upload 608, and compliance 610. The compliance element 610, when selected, causes an employee compliance tracking user interface (e.g., 700) to be displayed.

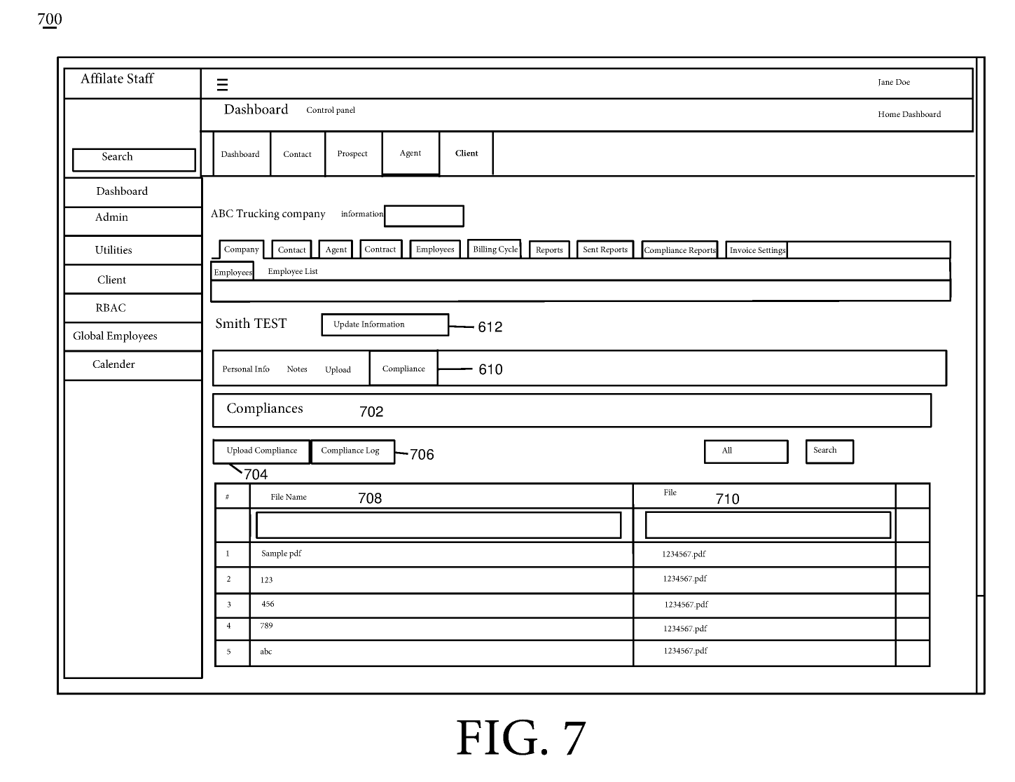

FIG. 7 is an example user interface 700 for electronic employee compliance tracking in an electronic employment document control system in accordance with some implementations. The compliance tracking interface 700 includes a compliance information section 702 having a listing of compliance documents (e.g., by filename 708 and file 710), an element to upload a new compliance document 704, and a compliance log for the employee 706. In addition to the compliance tracking interface 700, some implementations can provide compliance reports (accessed via the Compliance Reports tab) that can provide a visualization of what compliance documents employees have reviewed or have not reviewed. The Compliance Reports feature provides a way for employers to directly communicate with employees who have not opened up their compliance documents or report on their mobile application to read it. The communication can occur using the messaging technology described herein that can permit an employer to send a message to that employee letting him/her know (or reminding him/her) that a required compliance document needs to be reviewed (e.g., read for documents, listened to for audio, or watched for video). For compliance items that may require an employee's signature, the mobile application can provide employees with a way to capture an employee's signature by one or more of an electronic signature feature (e.g., where employee types his/her name and/or other identifying information), obtaining an electronic signature provided by the employee (e.g., by sensing the signature on a touch screen device), or capturing an image of the signed document and transmitting it to the employer system. The system can provide a feature for the employer to upload or attach documents that the employee has signed so that those documents are available via the cloud computing system and/or the mobile application for employer viewing/retrieval. Employees can also view documents that they have signed (electronically or manually) and uploaded.

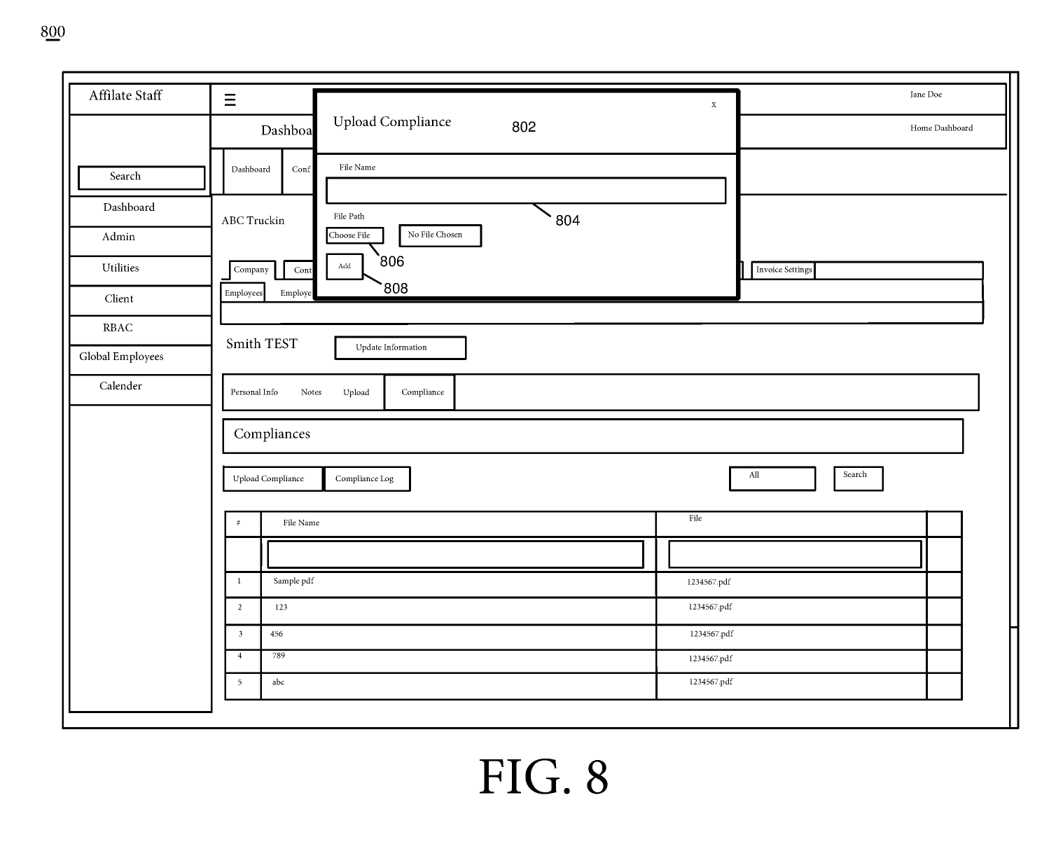

FIG. 8 is an example user interface 800 for uploading an electronic compliance document to an electronic employment document control system in accordance with some implementations. For example, if the upload compliance button (704) from FIG. 7 is selected, the upload compliance dialog box 802 shown in FIG. 8 is displayed. The upload compliance dialog box 802 includes elements for file name 804, selecting file name/location 806 (e.g., file browsing), and an element for uploading or adding 808 that, when selected, causes the compliance media file having the file name/location indicated in 804/806 to be uploaded to the system. Once uploaded, a compliance media file can be associated with one or more employees, which can cause the compliance media item to appear in the compliance list for the employee(s) that the uploaded compliance media file is associated with.

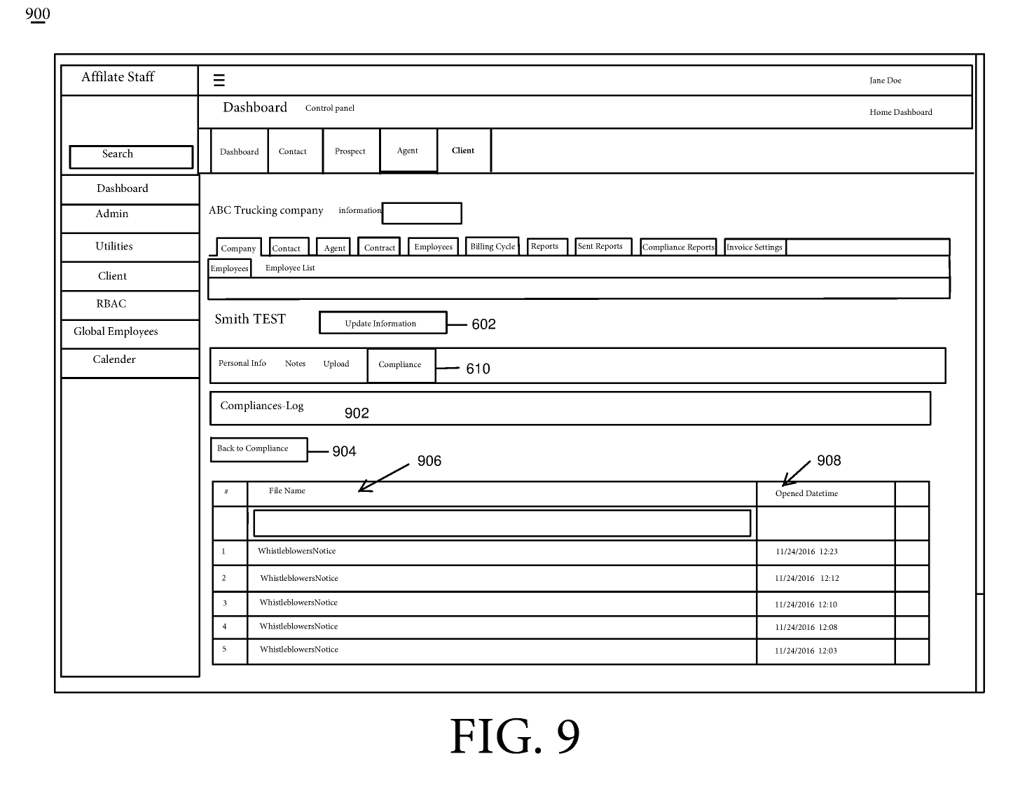

FIG. 9 is an example user interface 900 for an electronic compliance log 902 in an electronic employment document control system in accordance with some implementations. The interface 900 shows the compliance file 906 and the date and time 908 that the compliance file 906 was reviewed (e.g., opened, view, played, etc.) by the employee. The interface 902 also includes an element 904 to return to the compliance interface (e.g., 700). Federal and State governments update and implement new employment laws often (sometimes daily). At times, it may be mandated that employers disclose and document a date and time that compliance information (e.g., one or more compliance media files) has been delivered to one or more employees and the date and time that each of those employees have reviewed and/or been informed of the compliance information. Some implementations can help to electronically disseminate and keep records on required compliance information. In addition to physical letters being provided to employees upon being hired (e.g., according to law), employers can upload this information into a cloud portal implementation of the disclosed system and the information can be provided to and available for review for each applicable employee for which the information is required to be disclosed. Once an employee opens or reviews a compliance document (e.g., via a user interface on a mobile device), the compliance system can include a method of time stamping the opening of the compliance document without the employers ability to modify or delete the time stamp data. Sometimes employees do not work directly at their employer's place of business. For example, some employees work from home or they work off site. Some implementations provide a capability to implement government posting rules such as displaying in a conspicuous place at the workplace for offsite employees, for example, an implementation can cause such information to be displayed to the employee via a user interface on a mobile device application as described herein.

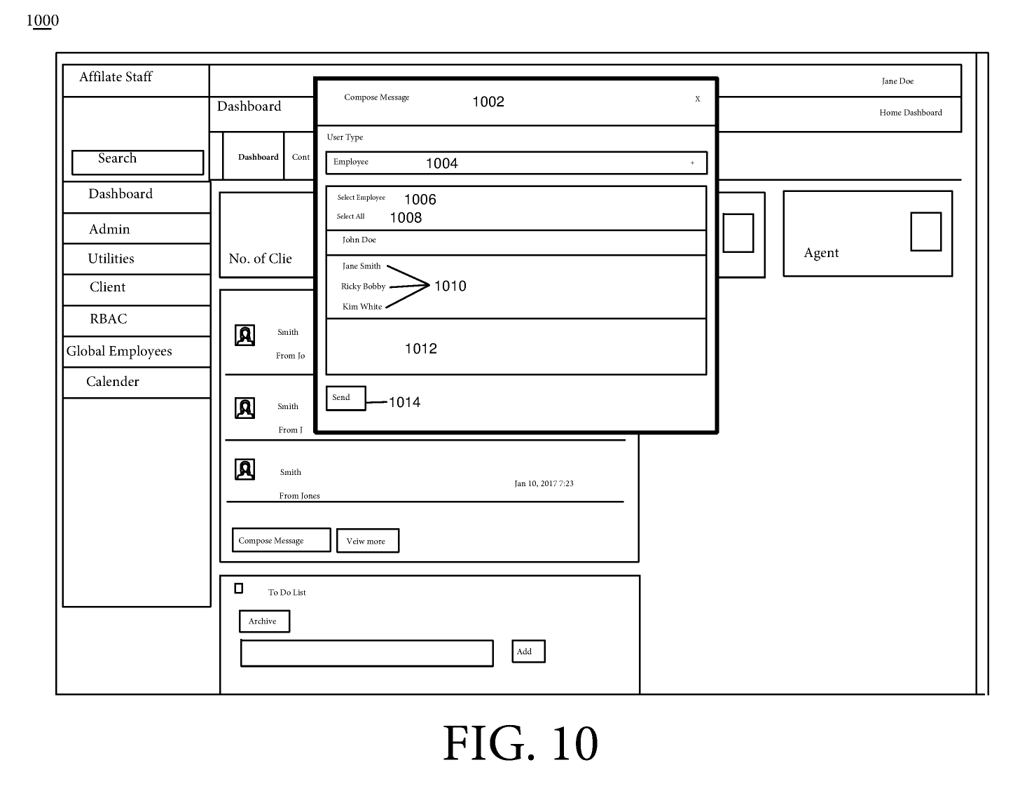

FIG. 10 is an example user interface 1000 for composing a message 1002 in an electronic employment document control system in accordance with some implementations. The interface 1000 includes a user type drop down selection element 1004 to select a user type to communicate with (e.g., employee, manager, HR, safety, executive, etc.) and an element 1006 for selecting individuals to send the message to. A select all element 1008 is also provided to select all individuals of the user type selected. The interface 1000 includes an individual user selected element 1010. The interface 1000 also includes a message compose element 1012 and a send element 1014.

FIG. 11 shows example user interfaces for a mobile application associated with an electronic employment document control system in accordance with some implementations. FIG. 11 shows an authentication mobile application user interface 1102 (e.g., similar to desktop application user interface FIG. 2). The interface 1102 includes elements for receiving credentials (e.g., email and password), signing in, indicating forgotten password, and logging in via other service (e.g., Facebook).

FIG. 11 also shows a business services menu interface 1104 having six icons corresponding to “My Job”, “My Profile”, “My Calendar”, “My Compliance”, “My Notes”, and “My Messages,” that, when selected, cause corresponding user interfaces (e.g., 1108, 1106, 1202, 1206, 1208, 1204, respectively).

FIG. 11 also shows an example profile interface 1106 corresponding to the “My Profile” icon. The profile interface 1106 includes fields for entering/reviewing/updating employee personal information (e.g., similar to the information shown in the interface of FIG. 6).

FIG. 11 also shows a job interface 1108 that corresponds to the “My Job” icon. The job interface 1108 shows past and current jobs of the employee.

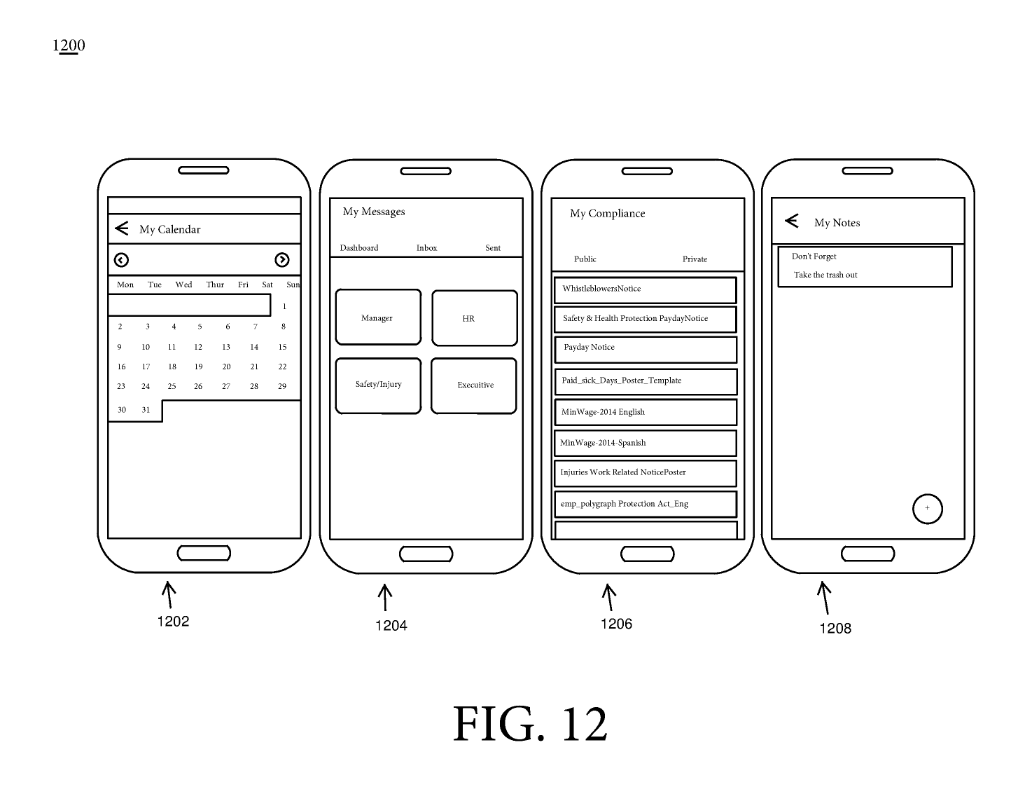

FIG. 12 shows example user interfaces for a mobile application associated with an electronic employment document control system in accordance with some implementations. The mobile application user interfaces include calendar 1202, messaging 1204 (showing categories of roles the employee can message such as manager, HR, safety/injury and executive), compliance 1206 and notes 1208.

The calendar user interface 1202 includes standard calendar functions.

The “My Messages” user interface 1204 includes elements that, when selected, permit the employee to compose and send a private and secure message to a manager, human resources (HR), safety/injury personnel, or an executive.

The compliance interface 1206 shows the public and private (selectable via the user interface) compliance documents that have been reviewed or otherwise acknowledged by the employee. The compliance interface 1206 can also show notifications for newly uploaded compliance media items awaiting employee review and for previously received compliance media items that have not been reviewed yet.

The notes interface 1208 includes elements permitting the employee to create, edit and delete notes.

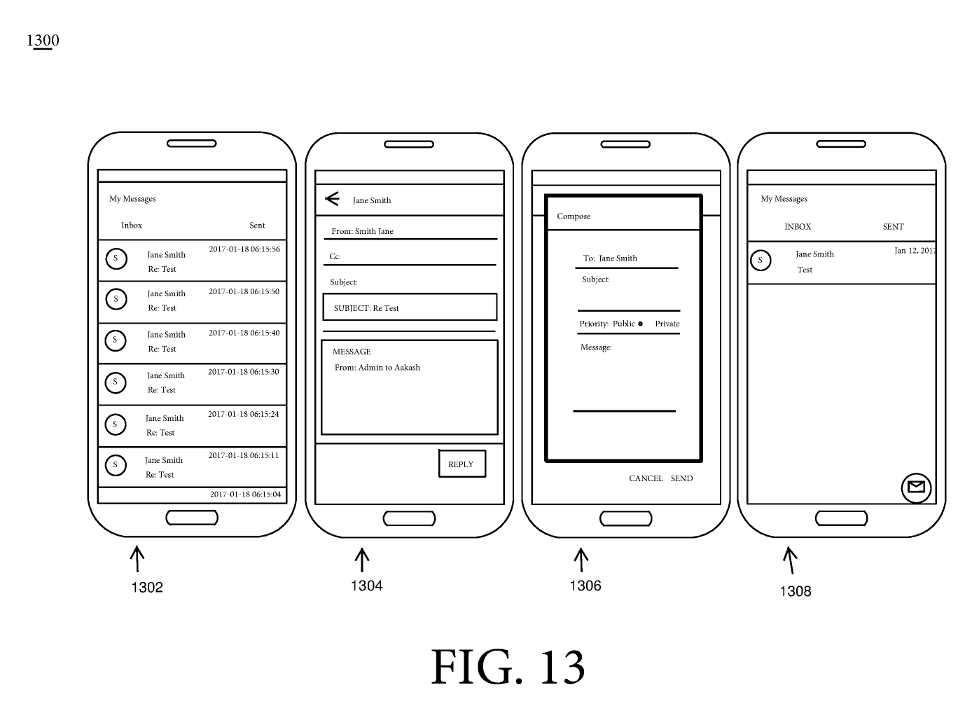

FIG. 13 shows example user interfaces for a mobile application associated with an electronic employment document control system in accordance with some implementations. The mobile application user interfaces include one for messages (“My Messages”) 1302 showing received and sent messages, a reply compose interface 1304 to compose a reply to a received messages, a new message compose interface 1306 to compose a new message, and a sent messages interface 1308.

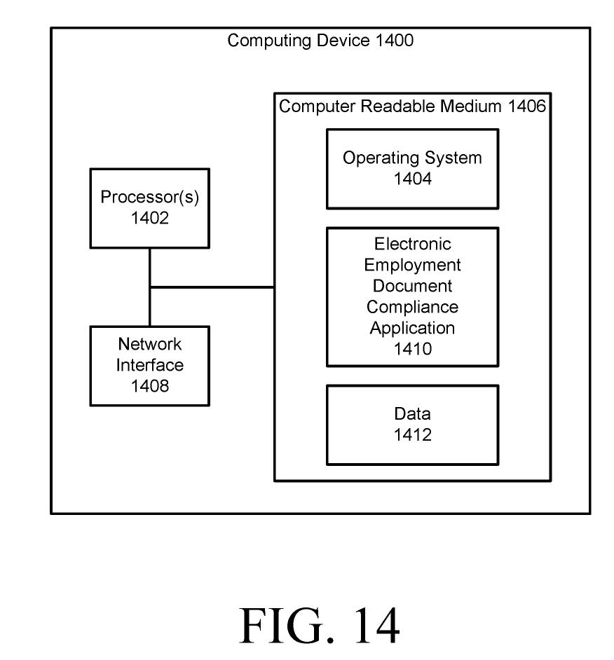

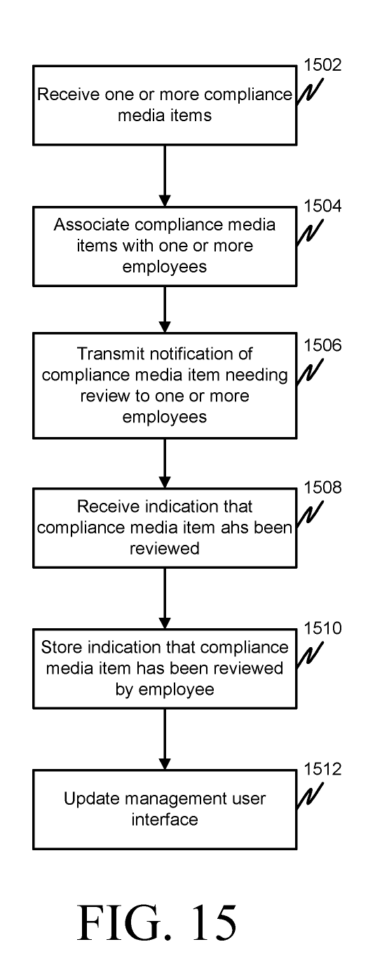

FIG. 14 is a diagram of an example computing device 1400 in accordance with at least one implementation. The computing device 1400 includes one or more processors 1402, nontransitory computer readable medium 1406 and network interface 1408. The computer readable medium 1406 can include an operating system 1404, an application 1410 for electronic employment document control and a data section 1412 (e.g., for storing employee data, documents, compliance records, electronic communication messages, etc.).

In operation, the processor 1402 may execute the application 1410 stored in the computer readable medium 1406. The application 1410 can include software instructions that, when executed by the processor, cause the processor to perform operations for electronic employment document control in accordance with the present disclosure (e.g., displaying and controlling user interfaces shown in FIGS. 2-13 and performing associated functions described above and in FIG. 15).

The application program 1410 can operate in conjunction with the data section 1412 and the operating system 1404.

FIG. 15 is a flowchart of an example method for electronic employment document control including a mobile application. Processing begins at 1502, a processor receives one or more compliance media items (e.g., via user interface 800). Processing continues to 1504.

At 1504, the processor associates the one or more compliance media items with one or more employee accounts corresponding to one or more employees, wherein the associating indicates that review of the compliance media item is required of the one or more employees. Processing continues to 1506.

At 1506, the processor transmits a notification to one or more mobile computing devices corresponding to the one or more employee accounts, wherein the notification includes an indication that the one or more compliance media items are awaiting review by the one or more employees. Processing continues to 1508.

At 1508, the processor receives an indication that the one or more compliance media items have been reviewed by the one or more employees. Processing continues to 1510.

At 1510, the processor stores the indication that the one or more compliance media items have been reviewed by the one or more employees to create a compliance audit trail for the one or more employees. Processing continues to 1512.

At 1512, the processor optionally updates a management user interface to indicate that the one or more compliance media items have been reviewed by the one or more employees.

In some implementations compliance media items can include, but are not limited to, one or more of federal posters postings, state poster postings, local poster postings, employee manual, IIPP, W/C coverage, and disclosures. Compliance media items can include documents, audio, or video files.

In some implementations, employment documentation can include, but are not limited to, executed documents, time stamp IP address communication logs, viewing stamp IP address logs, employee personal notes, and employee calendar.

In some implementations, communication can include, but is not limited to, messaging from employer to employee, messaging From employee to employer. Messaging can include instant messages within the employment document system. The instant messages can include instant messages form employee to HR, Manager, Executive, and Injury/Safety personnel.

Some implementations can include a video and/or audio transmission for an employee to view or listen to in place of, or in addition to, viewing a static document. The system can document the date, time, and other details (e.g., IP address, location (e.g., determined via mobile device location system such as GPS or the like), etc.) of the viewing or listening of an audio or video as documentation of the employee receiving the audio or video content that may contain compliance content. Some implementations can include a microphone button on the user interface for those employees who may have a physical challenge that may prevent or make difficult typing of messages. When pressed, the microphone button can cause the employee device (e.g., smart phone, etc.) to record an audio message from the employee and/or perform speech recognition on the detected audio and transcribe the spoken words into text to serve as a message or an attachment to a message sent within the system or to serve as a acknowledgement of receiving a document, video or audio.

Some implementations can also include a camera user interface element that when selected permits an employee to capture an image (e.g., still image and/or video) and upload it to the system so that the image becomes part of the employee's file and can be sent as an attachment to a message to a department such as safety, compliance, etc. The image capture feature can be used to document a safety hazard the employee wishes to report, etc. The image capture feature can also be used by the employee to document work status (e.g., completed work, work in progress, etc.). The image capture feature can be used to capture an image of a signed compliance media item (e.g., a signed document) for uploading as documentation of compliance.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for electronic employment document control including a mobile application.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
receiving, at a processor, one or more compliance media items;
associating, with the processor, the one or more compliance media items with one or more employee accounts corresponding to one or more employees, wherein the associating indicates that review of the compliance media item is required of the one or more employees;
transmitting, with the processor, a notification to one or more mobile computing devices corresponding to the one or more employee accounts, wherein the notification includes an indication that the one or more compliance media items are awaiting review by the one or more employees;
receiving, at the processor, an indication that the one or more compliance media items have been reviewed by the one or more employees;
storing, using the processor, the indication that the one or more compliance media items have been reviewed by the one or more employees to create a compliance audit trail for the one or more employees; and
updating, using the processor, a management user interface to indicate that the one or more compliance media items have been reviewed by the one or more employees.

2. The method of claim 1, wherein the one or more compliance media items include one of a document, an audio file, or a video file.

3. The method of claim 1, wherein the indication that the one or more compliance media items have been reviewed by the one or more employees includes one or more of a date the one or more compliance media items have been reviewed by the one or more employees, a time the one or more compliance media items have been reviewed by the one or more employees, a device used to review the one or more compliance media items by the one or more employees, or a location the one or more compliance media items were reviewed at by the one or more employees.

4. The method of claim 1, further comprising generating a report indicating which employees have reviewed or not reviewed the one or more compliance media items.

5. The method of claim 1, further comprising providing a communication interface between a management system and the one or more mobile computing devices corresponding to the one or more employee accounts, wherein the communications interface provides a private secure communications system for the one or more employees to communicate with one or more managers associated with the management system.

6. The method of claim 5, wherein the communications interface includes capabilities to permit the one or more employees to communicate with one or more of a manager, a human resources representative, a safety/injury representative, or an executive.

7. The method of claim 6, wherein communication messages with the one or more employees are stored to create a documentation trail for the one or more employees and management.

8. A system comprising:
a processor coupled to a nontransitory computer readable medium having stored thereon software instructions that, when executed by the processor, cause the processor to perform operations including:
receiving, at the processor, one or more compliance media items;
associating, with the processor, the one or more compliance media items with one or more employee accounts corresponding to one or more employees, wherein the associating indicates that review of the compliance media item is required of the one or more employees;
transmitting, with the processor, a notification to one or more mobile computing devices corresponding to the one or more employee accounts, wherein the notification includes an indication that the one or more compliance media items are awaiting review by the one or more employees;
receiving, at the processor, an indication that the one or more compliance media items have been reviewed by the one or more employees;
storing, using the processor, the indication that the one or more compliance media items have been reviewed by the one or more employees to create a compliance audit trail for the one or more employees; and
updating, using the processor, a management user interface to indicate that the one or more compliance media items have been reviewed by the one or more employees.

9. The system of claim 8, wherein the one or more compliance media items include one of a document, an audio file, or a video file.

10. The system of claim 8, wherein the indication that the one or more compliance media items have been reviewed by the one or more employees includes one or more of a date the one or more compliance media items have been reviewed by the one or more employees, a time the one or more compliance media items have been reviewed by the one or more employees, a device used to review the one or more compliance media items by the one or more employees, or a location the one or more compliance media items were reviewed at by the one or more employees.

11. The system of claim 8, wherein the operations further comprise generating a report indicating which employees have reviewed or not reviewed the one or more compliance media items.

12. The system of claim 8, wherein the operations further comprise providing a communication interface between a management system and the one or more mobile computing devices corresponding to the one or more employee accounts, wherein the communications interface provides a private secure communications system for the one or more employees to communicate with one or more managers associated with the management system.

13. The system of claim 12, wherein the communications interface includes capabilities to permit the one or more employees to communicate with one or more of a manager, a human resources representative, a safety/injury representative, or an executive.

14. The system of claim 13, wherein communication messages with the one or more employees are stored to create a documentation trail for the one or more employees and management.

15. A non-transitory computer readable medium having stored thereon software instructions that, when executed by a processor, cause the processor to perform operations including:
receiving, at the processor, one or more compliance media items;
associating, with the processor, the one or more compliance media items with one or more employee accounts corresponding to one or more employees, wherein the associating indicates that review of the compliance media item is required of the one or more employees;
transmitting, with the processor, a notification to one or more mobile computing devices corresponding to the one or more employee accounts, wherein the notification includes an indication that the one or more compliance media items are awaiting review by the one or more employees;
receiving, at the processor, an indication that the one or more compliance media items have been reviewed by the one or more employees;
storing, using the processor, the indication that the one or more compliance media items have been reviewed by the one or more employees to create a compliance audit trail for the one or more employees; and
updating, using the processor, a management user interface to indicate that the one or more compliance media items have been reviewed by the one or more employees.

16. The non-transitory computer readable medium of claim 15, wherein the one or more compliance media items include one of a document, an audio file, or a video file.

17. The non-transitory computer readable medium of claim 15, wherein the indication that the one or more compliance media items have been reviewed by the one or more employees includes one or more of a date the one or more compliance media items have been reviewed by the one or more employees, a time the one or more compliance media items have been reviewed by the one or more employees, a device used to review the one or more compliance media items by the one or more employees, or a location the one or more compliance media items were reviewed at by the one or more employees.

18. The non-transitory computer readable medium of claim 15, wherein the operations further comprise generating a report indicating which employees have reviewed or not reviewed the one or more compliance media items.

19. The non-transitory computer readable medium of claim 15, wherein the operations further comprise providing a communication interface between a management system and the one or more mobile computing devices corresponding to the one or more employee accounts, wherein the communications interface provides a private secure communications system for the one or more employees to communicate with one or more managers associated with the management system.

20. The non-transitory computer readable medium of claim 19, wherein the communications interface includes capabilities to permit the one or more employees to communicate with one or more of a manager, a human resources representative, a safety/injury representative, or an executive, and wherein communication messages with the one or more employees are stored to create a documentation trail for the one or more employees and management.
